(19) United States
(12) Patent Application Publication
(10) Pub. No.: US 2010/0151335 A1
(43) Pub. Date: Jun. 17, 2010

(54) SOLID ELECTROLYTE SHEET

(75) Inventors: Minoru Senga, Chiba (JP); Yoshikatsu Seino, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., Ltd., Chiyoda-ku (JP)

(21) Appl. No.: 11/997,026

(22) PCT Filed: Jul. 27, 2006
(86) PCT No.: PCT/JP2006/314836

§ 371 Date: May 22, 2008

(30) Foreign Application Priority Data
Aug. 2, 2005 (JP) 2005-223588

(51) Int. Cl. H01M 6/18

(52) U.S. Cl. 429/322

(57) ABSTRACT

A solid electrolyte sheet including: 80 to 99 wt % of an inorganic solid electrolyte, and 1 to 20 wt % of a binder; the inorganic solid electrolyte being obtainable by firing a raw material containing lithium sulfide (Li₂S) with phosphorus pentasulfide (P₂S₅), or elemental phosphorus and elemental sulfur.

### TECHNICAL FIELD

The invention relates to a solid electrolyte sheet. In more detail, the invention relates to a solid electrolyte sheet where mobile ions are a lithium ion and which can be used as a solid electrolyte member for high-voltage (4 V class) all-solid lithium batteries.

### BACKGROUND

An existing electrolyte for lithium rechargeable batteries utilizes an inflammable organic solvent and has risk such as ignition. A nonflammable electrolyte is effective for ensuring safety of a lithium rechargeable battery, and high-ion conductors therefore are developed.

However, these materials have insufficient proccessability and the resultant molded articles are hard and brittle. It is difficult to form a thin film or sheet from these materials. Consequently, when manufacturing batteries, there is a difficulty in handling them. Further improvements are demanded.

In view of the problems, for example, a lithium ion conductive solid electrolyte composite is disclosed which contains a lithium ion conductive inorganic solid electrolyte and a polymer (Patent Document 1, for example).

However, if the composite is used as a solid electrolyte for a high-voltage (4 V class) all-solid lithium battery, reduction reaction occurs at the time of discharge and charge, so that the battery does not stably operate.
[Patent Document 1] JP-A-2003-331912

In view of the above problems, an object of the invention is to provide a solid electrolyte sheet which has safety and proccessability and is neither oxidized nor reduced even when used in high-operating-voltage batteries.

### SUMMARY OF THE INVENTION

The inventors have developed a material which is an inorganic solid electrolyte containing lithium, phosphorus and sulfur as components and exhibits an extremely high Li ion conductivity (Japanese Patent Application No. 2004-35380). They found that a sheet formed by adding a binder to powder of the material possesses an excellent proccessability and extremely high Li ion conductivity. The invention is made based on the finding.
1. A solid electrolyte sheet comprising:

80 to 99 wt % of an inorganic solid electrolyte, and

1 to 20 wt % of a binder;

the inorganic solid electrolyte being obtainable by firing a raw material containing lithium sulfide (Li₂S) with phosphorus pentasulfide (P₂S₅), or elemental phosphorus and elemental sulfur.
2. The solid electrolyte sheet according to 1 wherein the inorganic solid electrolyte is obtainable by firing a sulfide-based glass comprising 68 to 74 mol % of Li₂S and 26 to 32 mol % of P₂S₅ at 150 to 360° C.
3. The solid electrolyte sheet according to 1 or 2 wherein the inorganic solid electrolyte has diffraction peaks at 2θ=17.8±0.3 deg, 18.2±0.3 deg, 19.8±0.3 deg, 21.8±0.3 deg, 23.8±0.3 deg, 25.9±0.3 deg, 29.5±0.3 deg and 30.0±0.3 deg in X-ray diffraction (CuKα: λ=1.5418 Å).
4. The solid electrolyte sheet according to any one of 1 to 3 which has an ion conductivity of 10⁻⁴ S/cm or more and a thickness of 5 to 500 μm.
5. The solid electrolyte sheet according to any one of 1 to 4 wherein the inorganic solid electrolytes are in contact with each other to form a continuous body and the continuous body imparts ion conductivity between one surface and the other opposing surface of the solid electrolyte sheet.
6. A lithium battery comprising the solid electrolyte sheet of any one of 1 to 5.

According to the invention, there can be provided a solid electrolyte sheet which has safety and proccessability and is neither oxidized nor reduced even when used in high-operating-voltage batteries.

### BRIEF DESCRIPTION OF DRAWINGS

FIGS. 1a-1c are schematic sections showing solid electrolyte sheets of the invention; FIG. 1a shows the structure where solid electrolyte particles are dispersed in a binder, FIG. 1b shows the structure where a thin film is formed from solid electrolyte particles spreading into a single layer and a binder connects the particles, and FIG. 1c shows the structure where solid electrolyte particles with different diameters are dispersed in a binder layer.

### BEST MODE FOR CARRYING OUT THE INVENTION

The solid electrolyte sheet of the invention will be specifically described.

The solid electrolyte sheet of the invention comprises 80 to 99 wt % of an inorganic solid electrolyte, and 1 to 20 wt % of a binder; the inorganic solid electrolyte being obtainable by firing a raw material containing lithium sulfide (Li₂S) with phosphorus pentasulfide (P₂S₅), or elemental phosphorus and elemental sulfur.

As the inorganic solid electrolyte used in the invention, a material obtainable by firing lithium sulfide with phosphorus pentasulfide, or elemental phosphorus and elemental sulfur is used. The solid electrolyte with this component composition exhibits a high Li ion conductivity, so that the resultant sheet can also maintain the excellent ion conductivity.

The solid electrolyte used in the invention is preferably an inorganic solid electrolyte obtainable by firing a sulfide-based glass including 68 to 74 mol % of Li₂S and 26 to 32 mol % of P₂S₅ at 150 to 360° C. The inorganic solid electrolyte thus treated has an extremely high lithium ion conductivity. The composition of sulfide-based glass is preferably 68 to 73 mol % of Li₂S and 32 to 27 mol % of P₂S₅.

The inorganic solid electrolyte used in the invention preferably has diffraction peaks at 2θ=17.8±0.3 deg, 18.2±0.3 deg, 19.8±0.3 deg, 21.8±0.3 deg, 23.8±0.3 deg, 25.9±0.3 deg, 29.5±0.3 deg, and 30.0±0.3 deg in X-ray diffraction (CuKα: λ=1.5418 Å).

An inorganic solid electrolyte having diffraction peaks in the above eight regions has an extremely high lithium conductivity.

A specific example of a method for producing the above inorganic solid electrolyte will be described below.

As Li₂S used as a starting material, Li₂S may be used which is prepared by reacting lithium hydroxide with hydrogen sulfide in an aprotic organic solvent to produce crude Li₂S and purifying the crude Li₂S by washing with an organic solvent at 100° C. or more.

In more detail, it is preferable to produce Li₂S by a method disclosed in JP-A-7-330312, and to purify the Li₂S by a method disclosed in WO 2005/040039 pamphlet. Specifically, the Li₂S was washed with an organic solvent at 100° C. or more.

According to this method for producing Li₂S, since high-purity lithium sulfide can be easily obtained, the raw material cost of sulfide-based glass can be reduced. According to the above purification method, since sulfur oxides and lithium N-methylaminobutyrate (hereinafter abbreviated as “LMAB”) which are impurities contained in Li₂S can be removed by a simple treatment, it is advantageous from an economical point of view. Moreover, a solid electrolyte for a lithium rechargeable battery using the high-purity lithium sulfide obtained can suppress a decrease in performance due to low purity, whereby an excellent lithium rechargeable battery (solid-state battery) can be obtained.

It is preferable that the total amount of sulfur oxides contained in the Li₂S be 0.15 mass % or less and the amount of LMAB contained in the Li₂S be 0.1 mass % or less.

P₂S₅ which is industrially produced and sold may be used without specific limitations.

Phosphorus (P) and sulfur (S) may be used at the molar ratio corresponding to P₂S₅ instead of P₂S₅. This allows the sulfide-based crystallized glass according to the invention to be produced using easily available and inexpensive materials. As phosphorus (P) and sulfur (S), those industrially produced and sold may be used without specific limitations.

Starting materials for the inorganic solid electrolyte used in the invention may contain at least one sulfide selected from the group consisting of Al₂S₃, B₂S₃ and SiS₂ in addition to P₂S₅ and Li₂S insofar as the ion conductivity is not lowered. The addition of such a sulfide allows the production of more stable glass when producing the sulfide-based glass.

Similarly, starting materials may contain at least one lithium orthooxo acid salt selected from the group consisting of Li₃PO₄, Li₄SiO₄, Li₄GeO₄, Li₃BO₃, and Li₃AlO₃ in addition to Li₂S and P₂S₅. The addition of such a lithium orthooxo acid salt stabilizes a glass component in the inorganic solid electrolyte.

Further, starting materials may contain at least one of the above-mentioned sulfides and at least one of the above-mentioned lithium orthooxo acid salts in addition to Li₂S and P₂S₅.

As a method for producing sulfide-based glass using a mixture of the above-mentioned starting materials, a mechanical milling treatment (hereinafter may be called “MM treatment”) or a melt-quenching method can be given, for example.

The MM treatment allows the production of sulfide-based glass from Li₂S and P₂S₅ of widely ranged compositions. Moreover, the MM treatment can be performed at room temperature since the heat treatment performed in the melt-quenching method becomes unnecessary, whereby the production process can be simplified.

When producing sulfide-based glass by the melt-quenching method or the MM treatment, it is preferable to use an inert gas atmosphere such as nitrogen. This is because steam, oxygen, or the like easily reacts with the starting materials.

In the MM treatment, it is preferable to use a ball mill. A large amount of mechanical energy can be produced by using the ball mill.

As the ball mill, it is preferable to use a planetary ball mill. The planetary ball mill, in which a pot rotates on its own axis and a plate revolves, can efficiently generate an extremely high impact energy.

The conditions for the MM treatment may be arbitrarily adjusted depending on instrument used and the like. The production rate of sulfide-based glass increases as the rotational speed increases, and the conversion rate of raw materials into sulfide-based glass increases as the rotational time increases. For example, when using a general planetary ball mill, the rotational speed may be several tens to several hundreds rotations per minute, and the treatment time may be 0.5 to 100 hours.

The sulfide-based glass obtained is crystallized by firing treatment to give an inorganic solid electrolyte. The firing temperature is preferably set at 150 to 360° C. If the temperature is less than 150° C., which is equal to or lower than the glass transition temperature of the sulfide-based glass, the effects of firing may be insufficient. If the temperature is more than 360° C., an inorganic solid electrolyte having an excellent ion conductivity may not be prepared. The firing temperature is preferably set at 200 to 350° C. The firing time is not particularly limited insofar as the ion conductivity sufficiently increases. The firing time may be extremely short or may be long.

As the binder used in the invention, thermoplastic resins or thermosetting resins can be used. Examples thereof include polysiloxane, polyalkyleneglycol, polyethylene, polypropylene, polytetrafluoroethylene (PTFE), polyvinylidene-fluoride (PVDF), tetrafluoroethylene-hexafluoroethylene copolymer, tetrafluoroethylene-hexafluoropropylene copolymer (FEP), tetrafluoroethylene-perfluoroalkylvinylether copolymer (PFA), vinylidene-fluoride-hexafluoropropylene copolymer, vinylidene-fluoride-chlorotrifluoroethylene copolymer, ethylene-tetrafluoroethylene copolymer (ETFE resin), polychlorotrifluoroethylene (PCTFE), vinylidene-fluoride-pentafluoropropylene copolymer, propylene-tetrafluoroethylene copolymer, ethylene-chlorotrifluoroethylene copolymer (ECTFE), vinylidene-fluoride-hexafluoropropylene-tetrafluoroethylene copolymer, vinylidene-fluoride-perfluoromethylvinylether-tetrafluoroethylene copolymer, ethylene-acrylic acid copolymer and Na⁺-ion bridged copolymer thereof, ethylene-methacrylic acid copolymer and Na⁺-ion bridged copolymer thereof, ethylene-methyl acrylate copolymer and Na⁺-ion bridged copolymer thereof, and ethylene-methyl methacrylate copolymer and Na⁺-ion bridged copolymer thereof.

Of these, preferred are polysiloxane, polyalkylene glycol, polyvinylidene-fluoride (PVDF) and polytetrafluoroethylene (PTEE).

Fibrous polytetrafluoroethylene is particularly preferable since the use thereof provides a high Li-ion conductive solid electrolyte sheet.

High molecular-weight compounds with an ion conductivity are preferably used for formation of the sheet to enhance the ion conductivity of the sheet. Such compounds include polymers of boron compounds described in JP-A-2004-182982 and polyether polymers with a siloxane bonding in the side chain containing a Li salt described in JP-A-2003-197030.

Nonwoven fabrics can also be used which can support an inorganic solid electrolyte. Examples thereof include ones formed of polytetrafluoroethylene, polyethylene and polypropylene.

The thickness thereof is not particularly limited but is preferably about 20 μm to about 1000 μm.

Methods for producing the solid electrolyte sheet include a method where a mixture of the above inorganic solid electrolyte and binder is press-molded, and a method where they are dispersed in a solvent to form a slurry and a film is formed from the slurry by doctor blading or spin coating.

In the case of press molding, a molding method changes depending on a binder used. However, for example, heating and compressing, roll drawing with dual-directional rollers and combination thereof can be used. In the case of using PTFE as a binder, roll drawing with dual-directional rollers is effective. The sheet thickness can be reduced by making the clearance between the dual-directional rollers narrow gradually.

When a slurry with an inorganic solid electrolyte and binder dispersed in a solvent is used for film formation by doctor blading or spin coating, nonpolar aprotic solvents are preferably used because the solid electrolyte hardly deteriorates therein. The nonpolar aprotic solvents are represented by hydrocarbon solvents such as hexane, heptane, octane, nonane, decan, decalin, toluene and xylene. Tetrahydrofuran and methylene chloride can also be given as a preferable solvent. Sulfide-based solid electrolytes generally tend to be easily hydrolyzed and, therefore, solvents with a small water content are preferably used. The water content in solvents is preferably 30 ppm or less, more preferably 10 ppm or less, particularly preferably 1 ppm or less.

In view of dispersibility in a sheet, an inorganic solid electrolyte preferably has an average particle diameter of 0.001 μm to 50 μm at the time of mixing. When adjusting the particle diameter of an inorganic solid electrolyte to such values, the inorganic solid electrolyte may be pulverized, if necessary. As a grinding method, a method using a ball mill such as a planetary mill, or a jet mill can be given. When pulverizing, a solvent may be used as required. As the solvent, the above nonpolar aprotic solvents can be preferably used.

In the invention, the content of an inorganic solid electrolyte is 80 to 99 wt % and the content of a binder is 1 to 20 wt % in the solid electrolyte sheet. If the content of an inorganic solid electrolyte is less than 80 wt %, the ion conductivity of the sheet decreases due to a shortage of an inorganic solid electrolyte in the sheet. If it exceeds 99 wt %, a binder cannot sufficiently impart flexibility to a sheet, so that the resultant sheet is hard and bristle. It is preferable that the content of an inorganic solid electrolyte be 90 to 98 wt % and the content of a binder be 10 to 2 wt % in the solid electrolyte sheet.

In addition to an inorganic solid electrolyte and binder, an additive having a lithium ion conductivity, e.g., ionic liquids, may be incorporated into the solid electrolyte sheet of the invention. Preferable ionic liquids include onium salts of ammonium type, pyridinium type and piperidinium type. The water content in an ionic liquid is preferably 10 ppm or less. If the water content exceeds 10 ppm, water may inactivate an inorganic solid electrolyte.

As a specific structure of the solid electrolyte sheet according to the invention, for example, the following three structures can be given. They will be described below with reference to the drawings.

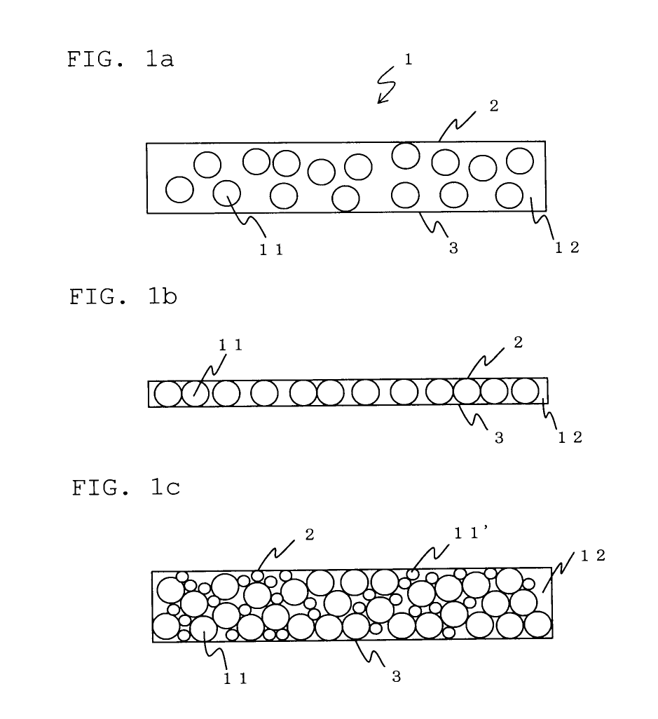

FIGS. 1a-1c are schematic sections showing solid electrolyte sheets of the invention; FIG. 1a shows the structure where solid electrolytes are dispersed in a binder, FIG. 1b shows the structure where a thin film is formed from solid electrolytes spreading into a single layer and a binder connects the solid electrolytes, and FIG. 1c shows the structure where solid electrolytes with different diameters are dispersed in a binder layer.

### (a) Structure Where Solid Electrolytes are Dispersed in a Binder

In the structure, as a binder 12, a conductive material (ionic conductive polymer, for example) is used. Since both solid electrolytes 11 and binder 12 are conductive, a sheet having a high ion conductivity can be obtained.

### (b) Structure Where Solid Electrolytes Spread in the State of a Single Layer to Form a Thin Film and a Binder is Present as a Connection Among the Solid Electrolytes

In this structure, solid electrolytes 11 are present as one layer in a sheet, providing an ion conductivity between the upper surface 2 and lower surface 3 of the sheet through the solid electrolytes.

(c) Structure Where Solid Electrolytes with Different Particle Diameters are Dispersed in a Binder Layer

In this structure, small solid electrolyte particles 11′ enter in gaps among large solid electrolyte particles 11 to form a continuous body where the solid electrolytes are in contact with each other. By the continuous body, a sheet with an ion conductivity between the upper and lower surfaces 2 and 3 can be obtained.

The solid electrolyte sheet of the invention preferably has an ion conductivity of 10⁻⁴ S/cm or more, particularly preferably 10⁻³ S/cm or more. An even higher ion conductivity is preferable but it may be difficult for the solid electrolyte sheet of the invention to obtain an ion conductivity over the 10⁻² S/cm order. Such an ion conductivity can suppress a reduction in efficiency when forming a lithium secondary battery, i.e., a reduction in a discharge amount relative to a charge amount.

The sheet thickness is preferably 5 to 500 μm, more preferably 10 to 200 μm. If it is less than 5 μm, a short circuit may occur between electrodes when forming a battery. If it exceeds 500 μm, the resistance of the solid electrolyte sheet may become larger, degrading the performance, particularly rate properties of the battery.

The solid electrolyte sheet of the invention is not reduced due to its high decomposition voltage even if it is used in a battery with an operating voltage of 4 V class. The solid electrolyte sheet of the invention also has a lithium ion transference number of 1 and is nonflammable since it mainly contains an inorganic solid electrolyte. The solid electrolyte sheet is thus a very suitable material for a solid electrolyte.

For use in a battery with an operating voltage of 4 V class, for example, the solid electrolyte sheet desirably has an initial discharge and charge efficiency of 70% or more in an operating voltage of 3.5 V.

The lithium battery of the invention can use known members in addition to the above solid electrolyte sheet. For example, lithium cobaltate may be used as a cathode active material and carbon graphite may be used as an anode active material. The use of the materials enables a lithium secondary battery with a high operating voltage (about 3.5 to 4 V).

### Examples

The invention will be specifically described by Examples.

### Production Example 1

### Formation of Inorganic Solid Electrolyte

### (1) Production of Lithium Sulfide (Li₂S)

Lithium sulfide was produced by the first aspect method (two step method) disclosed in JP-A-7-330312. Specifically, a 10-liter autoclave equipped with a stirring blade was charged with 3326.4 g (33.6 mol) of N-methyl-2-pyrrolidone (NMP) and 287.4 g (12 mol) of lithium hydroxide. The mixture was then heated to 130° C. with stirring at 300 rpm. Then, hydrogen sulfide was bubbled into the solution for two hours at a supply rate of 3 l/min. The temperature of the reaction solution was increased in a nitrogen stream (200 cc/min) to desulfurize and hydrogenate part of the hydrogen sulfide reacted. Water produced during the reaction between hydrogen sulfide and lithium hydroxide as a by-product started to vaporize as the temperature of the reaction mixture was increased. The water was condensed using a condenser and removed from the system. The temperature of the reaction mixture increased when water was removed from the system. The increase in temperature was stopped when the temperature reached 180° C., and the system was maintained at a constant temperature. After completion of removal of hydrogen sulfide (about 80 minutes), the reaction was terminated to obtain lithium sulfide.

### (2) Purification of Lithium Sulfide

After decanting the NMP in 500 mL of the slurry reaction solution (NMP-lithium sulfide slurry) obtained in (1), 100 mL of dehydrated NMP was added. The mixture was stirred at 105° C. for about one hour. The NMP was then decanted at 105° C. After the addition of 100 mL of NMP, the mixture was stirred at 105° C. for about one hour. The NMP was then decanted at 105° C. The same procedure was repeatedly performed four times in total. After completion of decantation, the lithium sulfide was dried at 230° C. (temperature equal to or higher than the boiling point of NMP) for three hours in a nitrogen stream under normal pressure. The impurity content of the lithium sulfide obtained was measured.

The content of sulfur oxides (lithium sulfite (Li₂SO₃), lithium sulfate (Li₂SO₄), and lithium thiosulfate (Li₂S₂O₃)) and lithium N-methylaminobutyrate (LMAB) was determined by ion chromatography. As a result, the total content of the sulfur oxides was 0.13 mass %, and the content of LMAB was 0.07 mass % .

Li₂S produced above and P₂S₅ (manufactured by Aldrich) were used as starting materials. About 1 g of a mixture prepared by mixing Li₂S and P₂S₅ at a molar ratio of 70:30 and ten alumina balls having a diameter of 10 mm were placed in an alumina container (45 mL). The contents of the container were subjected to a mechanical milling treatment in nitrogen at room temperature (25° C.) and a rotational speed of 370 rpm for 20 hours using a planetary ball mill (“P-7” manufactured by Fritsch) to obtain sulfide-based glass as a white yellow powder.

The powder (sulfide-based glass) was fired at a temperature from room temperature (25° C.) to 260° C. in a nitrogen atmosphere to form an inorganic solid electrolyte of crystallized sulfide-based glass. At this time, the temperature was raised and lowered at a speed of 10° C./minute. After reaching 260° C., the glass was cooled to room temperature.

The inorganic solid electrolyte thus obtained was subjected to X-ray powder diffraction measurement (CuKα: λ=1.5418 Å).

The inorganic solid electrolyte had diffraction peaks at 2θ=17.8 deg, 18.2 deg, 19.8 deg, 21.8 deg, 23.8 deg, 25.9 deg, 29.5 deg, and 30.0 deg.

The product obtained was pulverized in a mortar to obtain an inorganic solid electrolyte powder having a particle diameter of 3 to 10 μm. The particle diameter was measured under a scanning electron microscope.

This inorganic solid electrolyte had an ion conductivity of 2.1×10⁻³ S/cm.

### Production Example 2

### Synthesis of Binder

207.6 g (2.0 mole) of trimethyl borate was added to 230 g (1.0 mole) of dibutylenglycol monomethacrylate and 496 g (2.0 mole) of tributyleneglycol monomethyl ether. The mixture was allowed to stand with stirring at 60° C. for 1 hour in an atmosphere of dried air. The temperature was then raised to 75° C. After reaching 75° C., the pressure of the system was gradually reduced.

The pressure of 2.67 kPa (20 mmHg) or less was kept for 6 hours, during which volatile matters generated with progress in the borate ester exchange reaction and excessive trimethyl borate were removed. The resultant mixture was filtered to obtain 720 g of the following polymerizable boron-containing compound of formula 1.

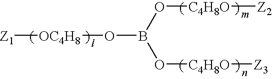

wherein Z₁ to Z₃ are a methacryloyl or methyl group, and l, m and n are 2 or 3.

The polymerizable boron-containing compound was measured for infrared absorption spectrum. As a result, the absorption band derived from a hydroxyl group at 3300 cm⁻¹ disappeared.

Next, mixed were 7.34 g (10 mmol) of the polymerizable boron-containing compound, 7.34 mg of 2,2′-azobisisobutylonitrile and 0.82 g (8.75 mmol) of LiBF₄ as an electrolyte salt. The solution was poured into a boat made of polytetrafluoroethylene and allowed to stand at 80° C. for 6 hours, thereby yielding a polymer electrolyte (binder).

A disc with a diameter of 1 cm was cut off from the electrolyte film thus obtained, and was sandwiched between a pair of stainless electrodes. This sample was measured for an ion conductivity at 25° C. by an ion conductivity measuring method described below. The ion conductivity was 0.8 mS/cm.

### Example 1

Dehydrated tetrohydrofuran was added to 9 g of the inorganic solid electrolyte powder produced in Production Example 1 and 1 g of the polymer electrolyte produced in Production Example 2. They were sufficiently mixed and stirred to form a slurry. The slurry was applied on a plate made of tetrafluoroethylene to form a film. The film was dried at 60° C. under reduced pressure and extended by applying pressure to obtain a 120-μm-thick solid electrolyte sheet.

The solid electrolyte sheet was evaluated for the following.

### (1) Ion Conductivity

An electrolyte sheet was sandwiched between stainless steal electrodes to form an electrochemical cell. An ion conductivity was measured by an AC impedance method where an alternating current was applied across the electrodes to measure resistance components. The ion conductivity was calculated from real number impedance intercepts of Cole-Cole plots.

### (2)Evaluation of Performance During Charge and Discharge

The following battery was formed for evaluation.

### Anode

Cell seed (lithium cobaltate, manufactured by Nippon Chemical Industrial Co., LTD.), SP270 (graphite, manufactured by Nippon Graphite Industries, Ltd.) and KF1120 (polyvinylidene-fluoride, manufactured by KUREHA CORPORATION) were mixed at a ratio of 80:10:10 by weight %. The mixture was added to N-methyl-2-pyrolidone to prepare a slurry. The slurry was applied on a 100-μm-thick stainless plate and dried. The film formed was rolled so that an anode layer had a thickness of 20 μm. A disc with a diameter of 1 cm was cut off therefrom as an anode.

### Cathode

CARBOTRON PE (amorphous carbon, manufactured by KUREHA CORPORATION) and KF1120 (polyvinylidene-fluoride, manufactured by KUREHA CORPORATION) were mixed at a ratio of 90:10 by weight %. The mixture was added to N-methyl-2-pyrolidone to prepare a slurry. The slurry was applied on a 100-μm-thick stainless plate and dried. The film formed was rolled so that a cathode layer has a thickness of 20 μm. A disc with a diameter of 1 cm was cut off therefrom as a cathode.

### Preparation of Battery Cell

A disc-like solid electrolyte sheet with a diameter of 1 cm prepared in each Example was sandwiched between the above anode and cathode such that the stainless plates on which the electrodes were formed were positioned outside the battery. They were adhered to each other under a load of 0.1 MPa at 80° C. to form a battery cell.

The battery cell was charged and discharged at 25° C. and a current density of 10 μA/cm² for measurement of the battery properties (initial charge and discharge efficiency). The initial charge and discharge efficiency was determined as a ratio of a discharge amount to an initial charge amount (mAh/g) (100%) per 1 g of lithium cobaltate.

As a result, the solid electrolyte sheet prepared in Example 1 had an ion conductivity of 1.0×10⁻³ S/cm. The initial charge and discharge efficiency just after formation of the battery was 78%. The operating voltage of the battery was 3.5 V [potential difference of the anode when the normal electrode potential of metal lithium was used as a standard (0 V) ] and the potential of the cathode active material was 0.1 V [potential difference of the cathode when the normal electrode potential of metal lithium was used as a standard (0 V)].

### Example 2

0.2 g of Teflon (registered trademark) fiber manufactured by DAIKIN INDUSTRIES, LTD (fiber length: 10 to 40 mm, fiber diameter: about 10 μm) was added to 9.8 g of the inorganic solid electrolyte prepared in Production Example 1 and sufficiently mixed in a mortar to produce an elastomer. The elastomer was extended with rollers to obtain a 200-μm-thick solid electrolyte sheet.

The sheet had an ion conductivity of 1.2×10⁻³ S/cm. It is probable that such a high ion conductivity was developed since inorganic solid electrolytes were in contact with each other to form a continuous body in the structure of the solid electrolyte sheet. Electron microscope photographs (SEM) of a section of the solid electrolyte sheet confirmed that a continuous body was formed from an inorganic solid electrolyte. The initial charge and discharge efficiency just after formation of the battery was 70%.

### Example 3

0.303 g of two-component silicone which will be cured by an addition reaction (viscosity: 900 mPa, two-component ratio: 100:100, manufactured by Dow Corning Toray Co., Ltd.) was added to 9.8 g of the inorganic solid electrolyte powder of Production Example 1. Dried heptane was further added thereto and sufficiently mixed.

The slurry obtained was applied on a tetrafluoroethlene plate and dried at 60° C. under reduced pressure to remove heptane. The resultant film was heated at 80° C. for 30 minutes and a solid electrolyte sheet with a thickness of 90 μm was obtained.

The sheet had an ion conductivity of 9.0×10⁻⁴ S/cm. It is probable that such a high ion conductivity was developed since inorganic solid electrolytes were in contact with each other to form a continuous body in the structure of the solid electrolyte sheet. Electron microscope photographs (SEM) of a section of the solid electrolyte sheet confirmed that a continuous body was formed from an inorganic solid electrolyte. The initial charge and discharge efficiency just after formation of the battery was 78%.

### Example 4

The inorganic solid electrolyte prepared in Production Example 1 was pulverized with a planetary ball mill in a similar way to Production Example 1 and classified with a 32-μm-opening sieve for adjusting the average particle diameter to 25 μm. 9.5 g of the powder and 0.5 g of a binder resin (polysiloxane) were suspended and dispersed in 25 ml of methylene chloride.

0.5 ml of the dispersion was coated on a tetrafluoroethylene plate with a spin coater to form a thin film. The film was naturally dried for a day to obtain a 25-μm-thick solid electrolyte sheet.

The sheet had an ion conductivity of 1.0×10⁻³ S/cm. It is probable that such a high ion conductivity was developed since inorganic solid electrolytes were in contact with each other to form a continuous body in the structure of the solid electrolyte sheet. Electron microscope photographs (SEM) of a section of the solid electrolyte sheet confirmed that a continuous body was formed from an inorganic solid electrolyte.

### Comparative Example 1

A solid electrolyte sheet was formed in a similar way to Example 1 except that an Si type electrolyte [0.01Li₃PO₄.0.63Li₂S.0.36SiS₂] was used instead of the inorganic solid electrolyte used in Example 1.

The sheet had an ion conductivity of 8×10⁻⁴ S/cm. The initial charge and discharge efficiency just after formation of the battery was as low as 15.0%. The potential of cathode active material in the battery was 0.1 V. However, the battery could not operate as a secondary battery since the cathode active material reduced the electrolyte. This showed that the electrolyte sheet could not be utilized in high-potential batteries.

### INDUSTRIAL APPLICABILITY

The solid electrolyte sheet of the invention can be used as a secondary battery solid electrolyte for cell phones, personal computers and automobiles, and is particularly useful as a solid electrolyte for secondary batteries used in automobiles.

1. A solid electrolyte sheet comprising:
80 to 99 wt % of an inorganic solid electrolyte, and
1 to 20 wt % of a binder;
the inorganic solid electrolyte being obtainable by firing a raw material containing lithium sulfide (Li₂S) with phosphorus pentasulfide (P₂S₅), or elemental phosphorus and elemental sulfur.

2. The solid electrolyte sheet according to claim 1 wherein the inorganic solid electrolyte is obtainable by firing a sulfide-based glass comprising 68 to 74 mol % of Li₂S and 26 to 32 mol % of P₂S₅ at 150 to 360° C.

3. The solid electrolyte sheet according to claim 1 wherein the inorganic solid electrolyte has diffraction peaks at 2θ=17.8±0.3 deg, 18.2±0.3 deg, 19.8±0.3 deg, 21.8±0.3 deg, 23.8±0.3 deg, 25.9±0.3 deg, 29.5±0.3 deg and 30.0±0.3 deg in X-ray diffraction (CuKα: λ=1.5418 Å).

4. The solid electrolyte sheet according to claim 1 which has an ion conductivity of 10⁻⁴ S/cm or more and a thickness of 5 to 500 μm.

5. The solid electrolyte sheet according to claim 1 wherein the inorganic solid electrolytes are in contact with each other to form a continuous body and the continuous body imparts ion conductivity between one surface and the other opposing surface of the solid electrolyte sheet.

6. A lithium battery comprising the solid electrolyte sheet of claim 1.

7. The solid electrolyte sheet according to claim 2 wherein the inorganic solid electrolyte has diffraction peaks at 2θ=17.8±0.3 deg, 18.2±0.3 deg, 19.8±0.3 deg, 21.8±0.3 deg, 23.8±0.3 deg, 25.9±0.3 deg, 29.5±0.3 deg and 30.0±0.3 deg in X-ray diffraction (CuKα: λ=1.5418 Å).

8. The solid electrolyte sheet according to claim 2 which has an ion conductivity of 10⁻⁴ S/cm or more and a thickness of 5 to 500 μm.

9. The solid electrolyte sheet according to claim 3 which has an ion conductivity of 10⁻⁴ S/cm or more and a thickness of 5 to 500 μm.

10. The solid electrolyte sheet according to claim 7 which has an ion conductivity of 10⁻⁴ S/cm or more and a thickness of 5 to 500 μm.

11. The solid electrolyte sheet according to claim 2 wherein the inorganic solid electrolytes are in contact with each other to form a continuous body and the continuous body imparts ion conductivity between one surface and the other opposing surface of the solid electrolyte sheet.

12. The solid electrolyte sheet according to claim 3 wherein the inorganic solid electrolytes are in contact with each other to form a continuous body and the continuous body imparts ion conductivity between one surface and the other opposing surface of the solid electrolyte sheet.

13. The solid electrolyte sheet according to claim 4 wherein the inorganic solid electrolytes are in contact with each other to form a continuous body and the continuous body imparts ion conductivity between one surface and the other opposing surface of the solid electrolyte sheet.

14. The solid electrolyte sheet according to claim 7 wherein the inorganic solid electrolytes are in contact with each other to form a continuous body and the continuous body imparts ion conductivity between one surface and the other opposing surface of the solid electrolyte sheet.

15. The solid electrolyte sheet according to claim 8 wherein the inorganic solid electrolytes are in contact with each other to form a continuous body and the continuous body imparts ion conductivity between one surface and the other opposing surface of the solid electrolyte sheet.

16. The solid electrolyte sheet according to claim 9 wherein the inorganic solid electrolytes are in contact with each other to form a continuous body and the continuous body imparts ion conductivity between one surface and the other opposing surface of the solid electrolyte sheet.

17. The solid electrolyte sheet according to claim 10 wherein the inorganic solid electrolytes are in contact with each other to form a continuous body and the continuous body imparts ion conductivity between one surface and the other opposing surface of the solid electrolyte sheet.
